(19) United States
(12) Patent Application Publication
(10) Pub. No.: US 2026/0146179 A1
(43) Pub. Date: May 28, 2026

(54) AQUEOUS RESIN, AQUEOUS COATING MATERIAL, AND ANTI-CORROSION COATING LAYER

(71) Applicant: INDUSTRIAL TECHNOLOGY RESEARCH INSTITUTE, Hsinchu (TW)

(72) Inventors: Chung Huan HSU, Hukou Township (TW); Wen-Pin CHUANG, Hsinchu City (TW); Hsi-Kang SHIH, New Taipei City (TW); Yu-Fen CHENG, Hsinchu City (TW); Cha-Wen CHANG, Hsinchu City (TW)

(73) Assignee: INDUSTRIAL TECHNOLOGY RESEARCH INSTITUTE, Hsinchu (TW)

(21) Appl. No.: 18/989,745

(22) Filed: Dec. 20, 2024

(30) Foreign Application Priority Data
Nov. 26, 2024 (TW) 113145521

(51) Int. Cl. C09D 135/06; C08F 222/08; C09D 5/02; C09D 5/08

(52) U.S. Cl. CPC C09D 135/06; C08F 222/08; C09D 5/02; C09D 5/08

(57) ABSTRACT

An aqueous resin is provided. The aqueous resin is an ammonium salt formed by reacting an aromatic acid with an alkaline compound neutralized ring-opening intermediate compound. The ring-opening intermediate compound is formed by performing a ring-opening reaction of a copolymer (containing maleic anhydride) using a tertiary amino alcohol. The copolymer containing maleic anhydride has a chemical structure of

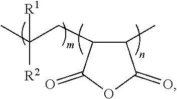

wherein R¹ is H or CH₃, R² is H, CH₃, or C₆H₅, m:n=1:3 to 3:1, and n=4 to 20. The tertiary amino alcohol has a chemical structure of

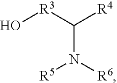

wherein R³ is C₁₋₁₀ alkylene group, R⁴ is H, C₁₋₁₀ alkyl group, or C₆₋₁₂ aromatic group, and each of R⁵ and R⁶ is independently C₁₋₁₀ alkyl group or C₆₋₁₂ aromatic group. The aromatic acid has a chemical structure of

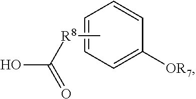

wherein R⁷ is H, C₁₋₁₀ alkyl group, or C₆₋₁₂ aromatic group, and R⁸ is C₁₋₅ alkylene group or

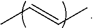

### CROSS REFERENCE TO RELATED APPLICATIONS

The present application is based on, and claims priority from, Taiwan Application Serial Number 113145521, filed on Nov. 26, 2024, the disclosure of which is hereby incorporated by reference herein in its entirety.

### TECHNICAL FIELD

The technical field relates to an aqueous resin.

### BACKGROUND

The major anti-corrosion coating materials for metal plates and screws in the current market are solvent-based, which do not satisfy the global carbon reduction trend. Although the aqueous anti-corrosion coating materials gradually receive attention, their performance is not good enough.

The poor performance of the aqueous anti-corrosion coating material is a result of the hydrophilicity of the aqueous resin of the aqueous anti-corrosion coating material. The hydrophilicity of the aqueous resin will influence the corrosion-resistant performance of the film formed from the coating material. If the hydrophilicity of the aqueous resin is too low, the compatibility and the stability of the coating material formulation will be influenced. If the hydrophilicity of the aqueous resin is too high, the corrosion-resistant effect of the film will be influenced. For addressing these issues, an aqueous resin with high corrosion resistance is called for to enhance the performance and widen the application field of the aqueous anti-corrosion coating material.

### SUMMARY

One embodiment of the disclosure provides an aqueous resin being an ammonium salt formed by reacting an aromatic acid with an alkaline compound neutralized ring-opening intermediate compound. The ring-opening intermediate compound is formed by performing a ring-opening reaction of a copolymer containing maleic anhydride with a tertiary amino alcohol. The copolymer containing maleic anhydride has a chemical structure of

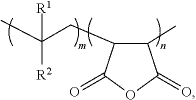

wherein R¹ is H or CH₃, R² is H, CH₃, or C₆H₅, m:n=1:3 to 3:1, and n=4 to 20. The tertiary amino alcohol has a chemical structure of

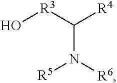

wherein R³ is C₁₋₁₀ alkylene group, R⁴ is H, C₁₋₁₀ alkyl group, or C₆₋₁₂ aromatic group, and each of R⁵ and R⁶ is independently C₁₋₁₀ alkyl group or C₆₋₁₂ aromatic group. The aromatic acid has a chemical structure of

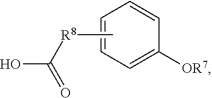

wherein R⁷ is H, C₁₋₁₀ alkyl group, or C₆₋₁₂ aromatic group, and R⁸ is C₁₋₅ alkylene group or

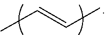

One embodiment of the disclosure provides an aqueous coating material, including 100 parts by weight of water and 50 to 100 parts by weight of the described aqueous resin.

One embodiment of the disclosure provides an anti-corrosion coating layer covering a surface of a metal article, wherein the anti-corrosion coating layer includes the described aqueous resin.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides an aqueous resin being an ammonium salt formed by reacting an aromatic acid with an alkaline compound neutralized ring-opening intermediate compound. The ring-opening intermediate compound is formed by performing a ring-opening reaction of a copolymer containing maleic anhydride with a tertiary amino alcohol. The copolymer containing maleic anhydride may have a chemical structure of

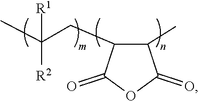

wherein R¹ is H or CH₃, R² is H, CH₃, or C₆H₅, m:n=1:3 to 3:1, and n=4 to 20. Note that the copolymer is a random copolymer rather than a block copolymer. The tertiary amino alcohol may have a chemical structure of

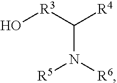

wherein R³ is C₁₋₁₀ alkylene group, R⁴ is H, C₁₋₁₀ alkyl group, or C₆₋₁₂ aromatic group, and each of R⁵ and R⁶ is independently C₁₋₁₀ alkyl group or C₆₋₁₂ aromatic group. The aromatic acid may have a chemical structure of

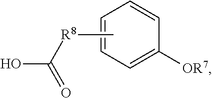

wherein R⁷ is H, C₁₋₁₀ alkyl group, or C₆₋₁₂ aromatic group, and R⁸ is C₁₋₅ alkylene group or

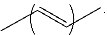

In one embodiment of the disclosure, the copolymer containing maleic anhydride is firstly reacted with the tertiary amino alcohol, i.e., the maleic anhydride of the copolymer containing maleic anhydride and the hydroxy group of the tertiary amino alcohol undergo the ring-opening reaction, to obtain the ring-opening intermediate compound. For example, the reaction is shown below:

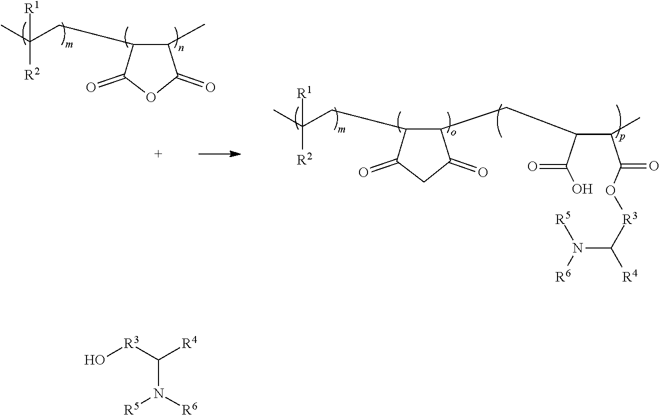

In the above formula, o+p=n, and p>0. o depends on the molar ratio of the maleic anhydride repeating unit to the tertiary amino alcohol. When the maleic anhydride repeating unit and the tertiary amino alcohol have a molar ratio of less than or equal to 1, it should be complete ring-opening in theory (o=0), but a little maleic anhydride may remain without ring-opening in practice (o is approximately 0). In short, o can be greater than or equal to 0.

The aqueous resin of the disclosure can be used in a coating material. In some embodiments, the aqueous resin of the disclosure is proposed to serve as a content of an anti-corrosion coating layer. The maleic anhydride repeating unit of the copolymer and the tertiary amino alcohol can have a molar ratio of 1:1.2 to 1:0.8. If the amount of the tertiary amino alcohol is too high, there will be too much free (unreacted) tertiary amino alcohol, it may influence the efficient amount of the subsequently formed ammonium salt to reduce the corrosion resistance of the coating layer. If the amount of the tertiary amino alcohol is too low, the amount of the subsequently formed ammonium salt will be insufficient and the corrosion resistance of the coating layer will be reduced.

Subsequently, the ring-opening intermediate product, an alkaline compound (e.g., ammonia, triethanolamine, or another alkaline solution), and appropriate amount of water were mixed to undergo neutralization, thereby obtaining the alkaline neutralized ring-opening intermediate product. When the alkaline is ammonia, the reaction is shown below:

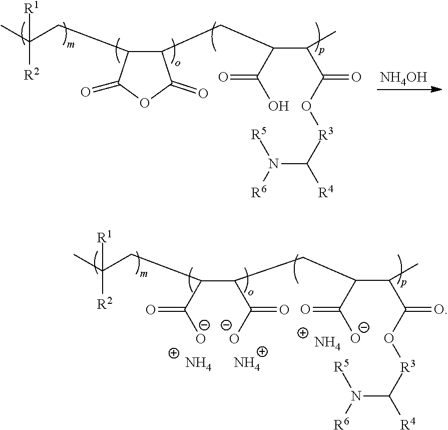

In the above reaction, the ammonia may neutralize the carboxylic acid from the ring-opening reaction of tertiary amino alcohol and maleic anhydride, further undergo a ring-opening reaction with the little maleic anhydride that was not ring-opened (if existing), and neutralize the carboxylic acid from the ring-opening reaction of ammonia and maleic anhydride. Theoretically, the molar number of the ammonia should be a sum of twice the molar number of the maleic anhydride that is not ring-opened and the molar number of the ring-opening maleic anhydride (i.e., 2o+p).

Subsequently, the neutralized ring-opening intermediate product and an aromatic acid are heated to 40° C. to 50° C. to perform a react, such that the carboxylic acid group of the aromatic acid and the tertiary amine group of the neutralized ring-opening intermediate product form an ammonium salt, thereby obtaining an aqueous solution of an aqueous resin. The reaction is shown below:

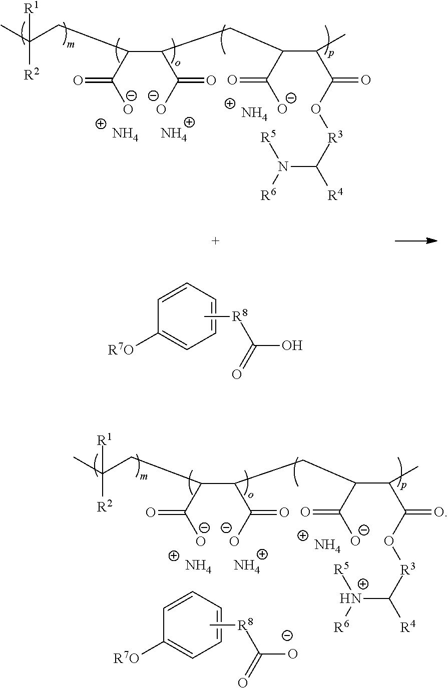

In some embodiments, when the aqueous resin of the disclosure is proposed to serve as a content of an anti-corrosion coating layer, the aromatic acid and the tertiary amino alcohol may have a molar ratio of 1.2:1 to 1:1. If the amount of the aromatic acid is too high or too low, the corrosion resistance of a coating layer formed from the aqueous resin will be lowered.

Note that if the neutralized ring-opening intermediate product and the aromatic acid are only mixed without being heated to react, the ammonium salt cannot be generated. When the mixture mentioned-above serving as a content of an anti-corrosion coating layer, the corrosion-resistant performance of the coating layer will be poor (See Comparative Example 6 in the disclosure).

On the other hand, if a primary amine compound (e.g., ethylene diamine or the like) is used to perform the ring-opening reaction, the prime amine of the neutralized ring-opening intermediate product and the aromatic acid will undergo an acylation reaction (see Comparative Example 3 in the disclosure) other than forming the ammonium salt. As such, when the aqueous resin formed from the above reaction is used as a content of the anti-corrosion coating layer, the corrosion-resistant performance of the coating layer will be poor.

In some embodiments, the copolymer containing maleic anhydride has a chemical structure of

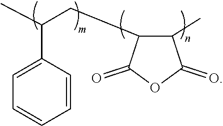

This copolymer is called styrene maleic anhydride copolymer (SMA).

In some embodiments, the tertiary amino alcohol has a chemical structure of

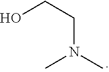

In some embodiments, the aromatic acid has a chemical structure of

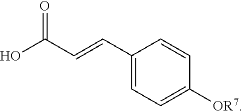

This aromatic acid is called coumaric acid (R⁷ is H) or coumaric acid derivative (R⁷ is C₁₋₁₀ alkyl group or C₆₋₁₂ aromatic group).

In some embodiments, when the aqueous resin is used to formulate an aqueous coating material for an anti-corrosion coating layer, the aqueous resin has a weight average molecular weight (Mw) of 1500 g/mol to 5000 g/mol. If the Mw of the aqueous resin is too high, the solubility of the aqueous resin will be decreased, and the effective content dissolved in water will be reduced to lower the corrosion resistance of the coating layer. If the Mw of the aqueous resin is too low, the film formability of the coating layer will be reduced, and the corrosion resistance of the coating layer will be lowered.

One embodiment of the disclosure provides an aqueous coating material, including 100 parts by weight of water and 50 to 100 parts by weight of the described aqueous resin. If the amount of the aqueous resin is too much, the aqueous resin will be precipitated and cannot be used. If the amount of the aqueous resin is too low, the film formability of the coating layer will be insufficient and the corrosion resistance of the coating layer will be reduced.

In some embodiments, the aqueous coating material may further include 0.1 to 3 parts by weight of an additive, and the additive can be leveling agent, defoaming agent, preservative, or a combination thereof. The additive is beneficial to improve the processability and storage ability of the coating material.

In some embodiments, when the aqueous coating material is used to form an anti-corrosion coating layer, it may further include 10 to 100 parts by weight of a sol-gel, wherein the sol-gel includes a silane compound, metal salt, and water. The sol-gel may further improve the corrosion resistance of the coating layer. As for the formation method and specific composition of the sol-gel may refer to Taiwan Patent No. TWI764461.

In one embodiment of the disclosure, the aqueous coating material can be used to a metal article. The aqueous coating material is coated to a surface of the metal article, and then dried to form an anti-corrosion coating layer covering the surface of the metal article, wherein the anti-corrosion coating layer includes the aqueous resin. In some embodiments, the anti-corrosion coating layer may further includes the described additive and the sol-gel. As known from experiments, the aqueous resin may efficiently improve the corrosion resistance of the anti-corrosion coating layer. The metal article can be screw, aluminum plate, or iron plate, but is not limited thereto.

Below, exemplary embodiments will be described in detail so as to be easily realized by a person having ordinary knowledge in the art. The inventive concept may be embodied in various forms without being limited to the exemplary embodiments set forth herein.

### EXAMPLES

### Example 1

500 g of styrene maleic anhydride copolymer (SMA, SMA1000 commercially available from Cray Valley), 178 g of dimethylethanolamine (DMAE, 2 mole), 3.5 g of acid catalyst p-toluenesulfonic acid (PTSA, 0.02 mole), and 400 mL of solvent methyl ethyl ketone were added into a reaction tank, then heated to 80° C. to 100° C. and stirred to react for 6 to 8 hours, and then cooled, filtered, and purified to obtain a ring-opening intermediate product. The reaction is shown below:

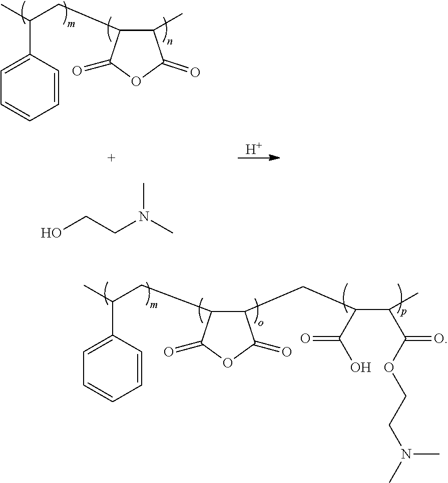

In the above formula, m=8, n=8, o+p=8, and o is approximately 0 (a little amount was not ring-opened).

The ring-opening intermediate product, ammonia, and an appropriate amount of water added into a reaction tank, then heated to 40° C. to 50° C. and stirred to react for 2 to 3 hours to obtain an ammonia neutralized ring-opening intermediate product. The reaction is shown below:

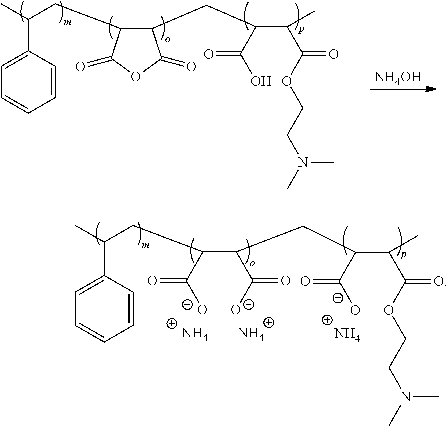

In the above reaction, the ammonia could neutralize the carboxylic acid group from the ring-opening reaction of DMAE and maleic anhydride, further undergo a ring-opening reaction with the little maleic anhydride that was not ring-opened, and neutralize the carboxylic acid group from the ring-opening reaction of ammonia and maleic anhydride.

Subsequently, 164 g of coumaric acid (1 mole) was added to the reaction tank containing the ammonia neutralized ring-opening intermediate product, then stirred at 40° C. to 50° C. to react for 1 to 2 hours. The carboxylic acid group of the coumaric acid and the tertiary amine group of the ammonia neutralized ring-opening intermediate product would form an ammonium salt, thereby obtaining an aqueous solution of an aqueous resin. The aqueous resin had a weight average molecular weight of 2400 g/mol. The reaction is shown below:

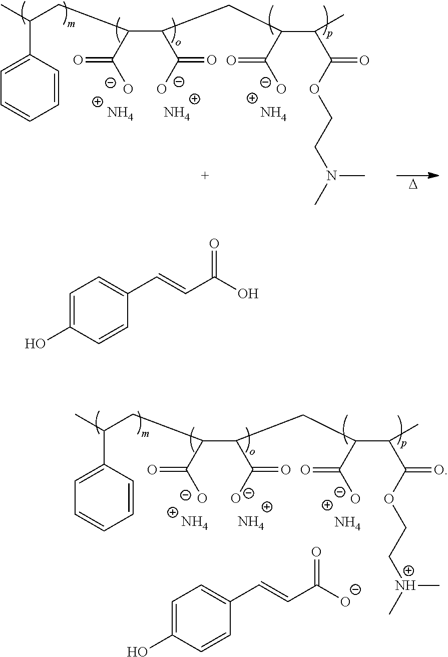

In the aqueous solution of the aqueous resin, the aqueous resin and water had a weight ratio of about 100:100. Additives such as 0.2 g of leveling agent (BYK333 commercially available from BYK), 0.1 g of defoaming agent (BYK021 commercially available from BYK), and 0.01 g of preservative (Kathon CG commercially available from Rohm and Haas) were added to 100 g of the aqueous solution of the aqueous resin and mixed, thereby obtaining an aqueous coating material. The contents in the aqueous coating material were compatible without suspension or precipitation. The prepared aqueous coating material was coated onto a stainless screw (series 4) to form a film with a thickness of 6 micrometers to 10 micrometers. The film was baked at 200° C. for 10 minutes to form an anti-corrosion coating layer on the screw. Then, the screw was taken to undergo a salt spray test according to the standard ASTM B117. The screw was corroded after about 600 hours in the salt spray test.

### Example 2

Example 1 was repeated, and the difference in Example 2 was 248 g of coumaric acid derivative (1 mole) being added to the reaction tank containing the ammonia neutralized ring-opening intermediate product, then stirred at 40° C. to 50° C. to react for 1 to 2 hours. The carboxylic acid group of the coumaric acid derivative and the tertiary amine group of the ammonia neutralized ring-opening intermediate product would form an ammonium salt, thereby obtaining an aqueous solution of an aqueous resin. The aqueous resin had a weight average molecular weight of 2500 g/mol. The reaction is shown below:

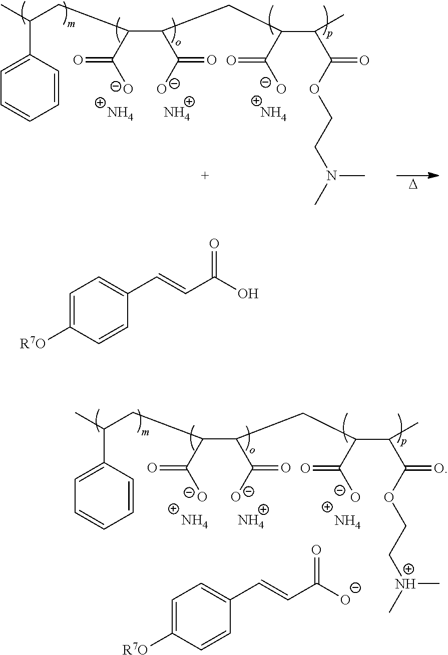

In the above formula, R⁷ is hexyl group.

In the aqueous solution of the aqueous resin, the aqueous resin and water had a weight ratio of about 100:100. Additives such as 0.2 g of leveling agent (BYK333 commercially available from BYK), 0.1 g of defoaming agent (BYK021 commercially available from BYK), and 0.01 g of preservative (Kathon CG commercially available from Rohm and Haas) were added to 100 g of the aqueous solution of the aqueous resin and mixed, thereby obtaining an aqueous coating material. The contents in the aqueous coating material were compatible without suspension or precipitation. The prepared aqueous coating material was coated onto a stainless screw (series 4) to form a film with a thickness of 6 micrometers to 10 micrometers. The film was baked at 200° C. for 10 minutes to form an anti-corrosion coating layer on the screw. Then, the screw was taken to undergo a salt spray test according to the standard ASTM B117. The screw was corroded after about 800 hours in the salt spray test.

### Example 3

Example 1 was repeated, and the difference in Example 3 was 254 g of coumaric acid derivative (1 mole) being added to the reaction tank containing the ammonia neutralized ring-opening intermediate product, then stirred at 40° C. to 50° C. to react for 1 to 2 hours. The carboxylic acid group of the coumaric acid derivative and the tertiary amine group of the ammonia neutralized ring-opening intermediate product would form an ammonium salt, thereby obtaining an aqueous solution of an aqueous resin. The aqueous resin had a weight average molecular weight of 2500 g/mol. The reaction is shown below:

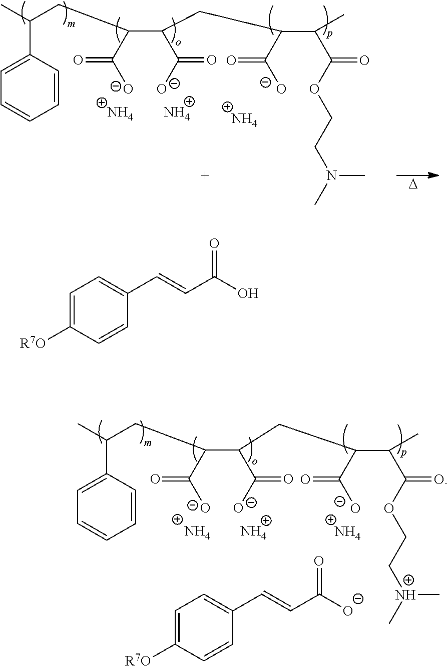

In the above formula, R⁷ is phenyl group.

In the aqueous solution of the aqueous resin, the aqueous resin and water had a weight ratio of about 100:100. Additives such as 0.2 g of leveling agent (BYK333 commercially available from BYK), 0.1 g of defoaming agent (BYK021 commercially available from BYK), and 0.01 g of preservative (Kathon CG commercially available from Rohm and Haas) were added to 100 g of the aqueous solution of the aqueous resin and mixed, thereby obtaining an aqueous coating material. The contents in the aqueous coating material were compatible without suspension or precipitation. The prepared aqueous coating material was coated onto a stainless screw (series 4) to form a film with a thickness of 6 micrometers to 10 micrometers. The film was baked at 200° C. for 10 minutes to form an anti-corrosion coating layer on the screw. Then, the screw was taken to undergo a salt spray test according to the standard ASTM B117. The screw was corroded after about 800 hours in the salt spray test.

### Example 4

500 g of styrene maleic anhydride copolymer (SMA, SMA1000F commercially available from Cray Valley), 178 g of DMAE (2 mole), 3.5 g of PTSA (0.02 mole), and 400 mL of solvent methyl ethyl ketone were added into a reaction tank, then heated to 80° C. to 100° C. and stirred to react for 6 to 8 hours, and then cooled, filtered, and purified to obtain a ring-opening intermediate product. The reaction is shown below:

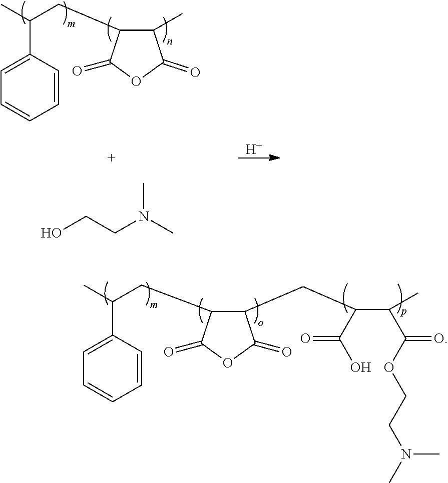

In the above formula, m=16, n=16, o+p=16, and o is approximately 0 (a little amount was not ring-opened).

The ring-opening intermediate product, ammonia, and an appropriate amount of water added into a reaction tank, then heated to 40° C. to 50° C. and stirred to react for 2 to 3 hours to obtain an ammonia neutralized ring-opening intermediate product. The reaction is shown below:

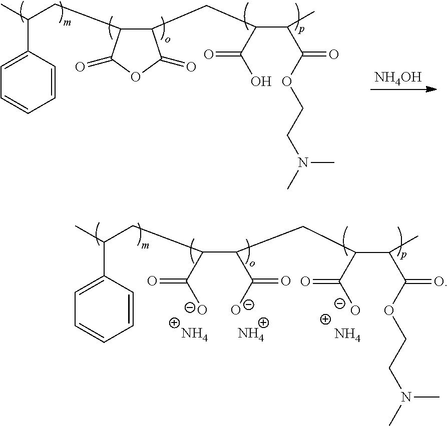

In the above reaction, the ammonia could neutralize the carboxylic acid group from the ring-opening reaction of DMAE and maleic anhydride, further undergo a ring-opening reaction with the little maleic anhydride that was not ring-opened, and neutralize the carboxylic acid group from the ring-opening reaction of ammonia and maleic anhydride.

Subsequently, 164 g of coumaric acid (1 mole) was added to the reaction tank containing the ammonia neutralized ring-opening intermediate product, then stirred at 40° C. to 50° C. to react for 1 to 2 hours. The carboxylic acid group of the coumaric acid and the tertiary amine group of the ammonia neutralized ring-opening intermediate product would form an ammonium salt, thereby obtaining an aqueous solution of an aqueous resin. The aqueous resin had a weight average molecular weight of 4500 g/mol. The reaction is shown below:

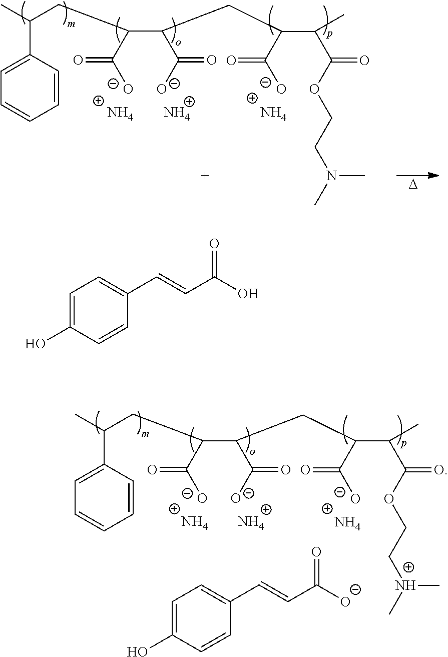

In the aqueous solution of the aqueous resin, the aqueous resin and water had a weight ratio of about 100:100. Additives such as 0.2 g of leveling agent (BYK333 commercially available from BYK), 0.1 g of defoaming agent (BYK021 commercially available from BYK), and 0.01 g of preservative (Kathon CG commercially available from Rohm and Haas) were added to 100 g of the aqueous solution of the aqueous resin and mixed, thereby obtaining an aqueous coating material. The contents in the aqueous coating material were compatible without suspension or precipitation. The prepared aqueous coating material was coated onto a stainless screw (series 4) to form a film with a thickness of 6 micrometers to 10 micrometers. The film was baked at 200° C. for 10 minutes to form an anti-corrosion coating layer on the screw. Then, the screw was taken to undergo a salt spray test according to the standard ASTM B117. The screw was corroded after about 600 hours in the salt spray test.

### Example 5

750 g of styrene maleic anhydride copolymer (SMA, SMA2000 commercially available from Cray Valley), 178 g of DMAE (2 mole), 3.5 g of PTSA (0.02 mole), and 400 mL of solvent methyl ethyl ketone were added into a reaction tank, then heated to 80° C. to 100° C. and stirred to react for 6 to 8 hours, and then cooled, filtered, and purified to obtain a ring-opening intermediate product. The reaction is shown below:

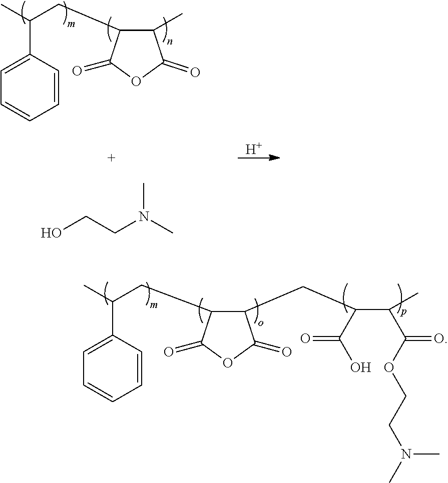

In the above formula, m=16, n=8, o+p=8, and o is approximately 0 (a little amount was not ring-opened).

The ring-opening intermediate product, ammonia, and an appropriate amount of water added into a reaction tank, then heated to 40° C. to 50° C. and stirred to react for 2 to 3 hours to obtain an ammonia neutralized ring-opening intermediate product. The reaction is shown below:

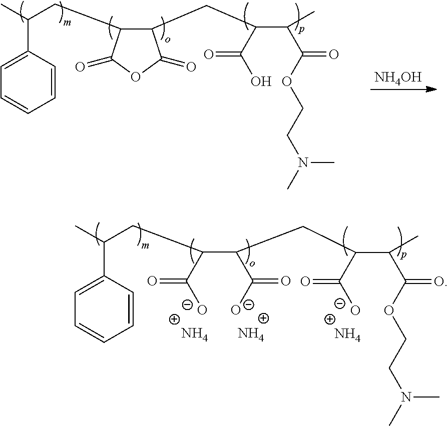

In the above reaction, the ammonia could neutralize the carboxylic acid group from the ring-opening reaction of DMAE and maleic anhydride, further undergo a ring-opening reaction with the little maleic anhydride that was not ring-opened, and neutralize the carboxylic acid group from the ring-opening reaction of ammonia and maleic anhydride.

Subsequently, 164 g of coumaric acid (1 mole) was added to the reaction tank containing the ammonia neutralized ring-opening intermediate product, then stirred at 40° C. to 50° C. to react for 1 to 2 hours. The carboxylic acid group of the coumaric acid and the tertiary amine group of the ammonia neutralized ring-opening intermediate product would form an ammonium salt, thereby obtaining an aqueous solution of an aqueous resin. The aqueous resin had a weight average molecular weight of 3400 g/mol. The reaction is shown below:

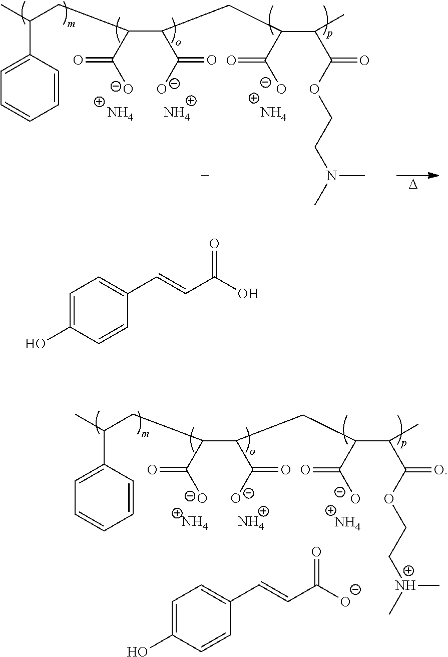

In the aqueous solution of the aqueous resin, the aqueous resin and water had a weight ratio of about 100:100. Additives such as 0.2 g of leveling agent (BYK333 commercially available from BYK, 0.1 g of defoaming agent (BYK021 commercially available from BYK), and 0.01 g of preservative (Kathon CG commercially available from Rohm and Haas) were added to 100 g of the aqueous solution of the aqueous resin and mixed, thereby obtaining an aqueous coating material. The contents in the aqueous coating material were compatible without suspension or precipitation. The prepared aqueous coating material was coated onto a stainless screw (series 4) to form a film with a thickness of 6 micrometers to 10 micrometers. The film was baked at 200° C. for 10 minutes to form an anti-corrosion coating layer on the screw. Then, the screw was taken to undergo a salt spray test according to the standard ASTM B117. The screw was corroded after about 600 hours in the salt spray test.

### Comparative Example 1

100 g of SMA (SMA1000 commercially available from Cray Valley), 100 g of water, 0.2 g of leveling agent (BYK333 commercially available from BYK), 0.1 g of defoaming agent (BYK021 commercially available from BYK), and 0.01 g of preservative (Kathon CG commercially available from Rohm and Haas) were mixed but could not be compatible, which failed to serve as an aqueous coating material.

### Comparative Example 2

Water was added to the ammonia neutralized ring-opening intermediate product in Example 1 to form an aqueous solution, in which the ammonia neutralized ring-opening intermediate product and water had a weight ratio of 100:100. Additives such as 0.2 g of leveling agent (BYK333 commercially available from BYK), 0.1 g of defoaming agent (BYK021 commercially available from BYK), and 0.01 g of preservative (Kathon CG commercially available from Rohm and Haas) were added to 100 g of the aqueous solution of the ammonia neutralized ring-opening intermediate product to obtain an aqueous coating material. The contents in the aqueous coating material were compatible without suspension or precipitation. The prepared aqueous coating material was coated onto a stainless screw (series 4) to form a film with a thickness of 6 micrometers to 10 micrometers. The film was baked at 200° C. for 10 minutes to form an anti-corrosion coating layer on the screw. Then, the screw was taken to undergo a salt spray test according to the standard ASTM B117. The screw was corroded after about 200 hours in the salt spray test.

### Comparative Example 3

500 g of SMA (SMA1000 commercially available from Cray Valley), 60 g of ethylene diamine (1 mole), 3.5 g of PTSA (0.02 mole), and 400 mL of solvent methyl ethyl ketone were added into a reaction tank, then stirred at room temperature to react for 12 hours, and then filtered and purified to obtain a ring-opening intermediate product. The reaction is shown below:

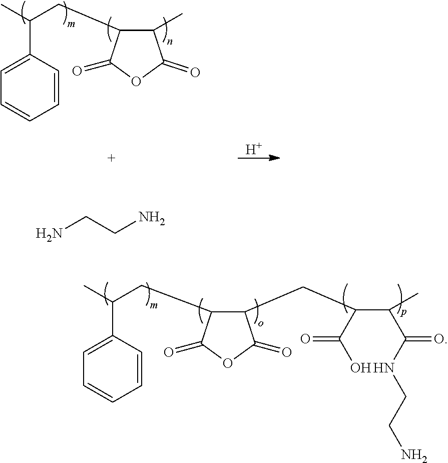

In the above formula, m=8, n=8, o+p=8, and o is approximately 0 (a little amount was not ring-opened).

560 g of the ring-opening intermediate product, 164 g of coumaric acid (1 mole), and 3.1 g of catalyst N-Ethyl-N′-(3-dimethylaminopropyl)carbodiimide hydrochloride (EDC) were mixed and stirred at room temperature for 24 hours. The primary amine group of the ring-opening intermediate product and the carboxylic acid group of the coumaric acid were reacted to form amide, thereby obtaining an aqueous solution of an aqueous resin. The reaction is shown below:

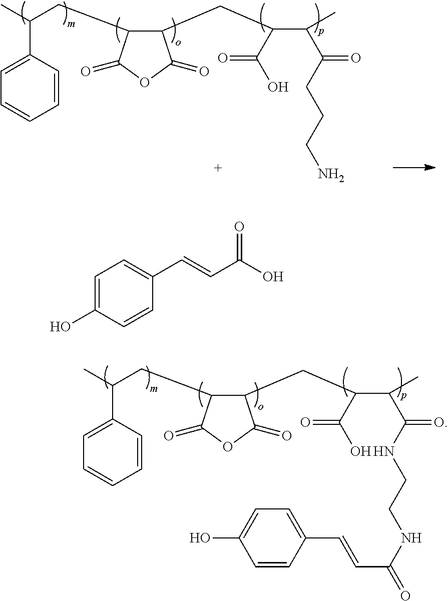

In the aqueous solution of the aqueous resin, the aqueous resin and water had a weight ratio of about 100:100. Additives such as 0.2 g of leveling agent (BYK333 commercially available from BYK), 0.1 g of defoaming agent (BYK021 commercially available from BYK), and 0.01 g of preservative (Kathon CG commercially available from Rohm and Haas) were added to 100 g of the aqueous solution of the aqueous resin and mixed, thereby obtaining an aqueous coating material. The contents in the aqueous coating material were compatible without suspension or precipitation. The prepared aqueous coating material was coated onto a stainless screw (series 4) to form a film with a thickness of 6 micrometers to 10 micrometers. The film was baked at 200° C. for 10 minutes to form an anti-corrosion coating layer on the screw. Then, the screw was taken to undergo a salt spray test according to the standard ASTM B117. The screw was corroded after about 400 hours in the salt spray test.

### Comparative Example 4

Polyester (Gardobond® commercially available from BASF) serving as an aqueous resin was dissolved in water. In the aqueous solution of the aqueous resin, the aqueous resin and water had a weight ratio of about 100:100. Additives such as 0.2 g of leveling agent (BYK333 commercially available from BYK), 0.1 g of defoaming agent (BYK021 commercially available from BYK), and 0.01 g of preservative (Kathon CG commercially available from Rohm and Haas) were added to 100 g of the aqueous solution of the aqueous resin and mixed, thereby obtaining an aqueous coating material. The contents in the aqueous coating material were compatible without suspension or precipitation. The prepared aqueous coating material was coated onto a stainless screw (series 4) to form a film with a thickness of 6 micrometers to 10 micrometers. The film was baked at 200° C. for 10 minutes to form an anti-corrosion coating layer on the screw. Then, the screw was taken to undergo a salt spray test according to the standard ASTM B117. The screw was corroded after about 100 hours in the salt spray test.

### Comparative Example 5

A stainless screw (series 4) was selected to undergo a salt spray test according to the standard ASTM B117. The screw was corroded after less than 72 hours in the salt spray test.

### Example 6

50 g of corrosion inhibition agent such as a sol-gel (containing silane compound, metal salt, and water, see Example 1 in Taiwan Patent No. TWI764461) was added into the aqueous coating material in Example 2. The contents in the aqueous coating material were compatible without suspension or precipitation. The prepared aqueous coating material was coated onto a stainless screw (series 4) to form a film with a thickness of 6 micrometers to 10 micrometers. The film was baked at 200° C. for 10 minutes to form an anti-corrosion coating layer on the screw. Then, the screw was taken to undergo a salt spray test according to the standard ASTM B117. The screw was corroded after longer than 1000 hours in the salt spray test.

### Comparative Example 6

Example 1 was repeated, and the difference in comparative Example 6 was 164 g of coumaric acid (1 mole) being added to the reaction tank containing the ammonia neutralized ring-opening intermediate product, then mixed (rather than forming the ammonium salt by making a reaction of the carboxylic acid group of the coumaric acid with the tertiary amine group of the ammonia neutralized ring-opening intermediate product), thereby obtaining an aqueous solution of an aqueous resin (e.g., the mixture of the ammonia neutralized ring-opening intermediate product and the coumaric acid).

In the aqueous solution of the aqueous resin, the aqueous resin and water had a weight ratio of about 100:100. Additives such as 0.2 g of leveling agent (BYK333 commercially available from BYK), 0.1 g of defoaming agent (BYK021 commercially available from BYK), and 0.01 g of preservative (Kathon CG commercially available from Rohm and Haas) were added to 100 g of the aqueous solution of the aqueous resin and mixed, thereby obtaining an aqueous coating material. The contents in the aqueous coating material were compatible without suspension or precipitation. The prepared aqueous coating material was coated onto a stainless screw (series 4) to form a film with a thickness of 6 micrometers to 10 micrometers. The film was baked at 200° C. for 10 minutes to form an anti-corrosion coating layer on the screw. Then, the screw was taken to undergo a salt spray test according to the standard ASTM B117. The screw was corroded after about 300 hours in the salt spray test.

### Comparative Example 7

Polyester (Gardobond® commercially available from BASF) serving as an aqueous resin was dissolved in water. In the aqueous solution of the aqueous resin, the aqueous resin and water had a weight ratio of about 100:100. Additives such as 0.2 g of leveling agent (BYK333 commercially available from BYK), 0.1 g of defoaming agent (BYK021 commercially available from BYK), 0.01 g of preservative (Kathon CG commercially available from Rohm and Haas), and 5 g of coumaric acid were added to 100 g of the aqueous solution of the aqueous resin and mixed, thereby obtaining an aqueous coating material. The contents in the aqueous coating material were compatible without suspension or precipitation. The prepared aqueous coating material was coated onto a stainless screw (series 4) to form a film with a thickness of 6 micrometers to 10 micrometers. The film was baked at 200° C. for 10 minutes to form an anti-corrosion coating layer on the screw. Then, the screw was taken to undergo a salt spray test according to the standard ASTM B117. The screw was corroded after about 300 hours in the salt spray test.

### Comparative Example 8

Polyester (Gardobond® commercially available from BASF) serving as an aqueous resin was dissolved in water. In the aqueous solution of the aqueous resin, the aqueous resin and water had a weight ratio of about 100:100. Additives such as 0.2 g of leveling agent (BYK333 commercially available from BYK), 0.1 g of defoaming agent (BYK021 commercially available from BYK), 0.01 g of preservative (Kathon CG commercially available from Rohm and Haas), and 50 g of sol-gel (containing silane compound, metal salt, and water, see Example 1 in Taiwan Patent No. TWI764461) were added to 100 g of the aqueous solution of the aqueous resin and mixed, thereby obtaining an aqueous coating material. The contents in the aqueous coating material were compatible without suspension or precipitation. The prepared aqueous coating material was coated onto a stainless screw (series 4) to form a film with a thickness of 6 micrometers to 10 micrometers. The film was baked at 200° C. for 10 minutes to form an anti-corrosion coating layer on the screw. Then, the screw was taken to undergo a salt spray test according to the standard ASTM B117. The screw was corroded after about 200 hours in the salt spray test.

### Comparative Example 9

Polyester (Gardobond® commercially available from BASF) serving as an aqueous resin was dissolved in water. In the aqueous solution of the aqueous resin, the aqueous resin and water had a weight ratio of about 100:100. Additives such as 0.2 g of leveling agent (BYK333 commercially available from BYK), 0.1 g of defoaming agent (BYK021 commercially available from BYK), 0.01 g of preservative (Kathon CG commercially available from Rohm and Haas), 5 g of coumaric acid, and 50 g of sol-gel (containing silane compound, metal salt, and water, see Example 1 in Taiwan Patent No. TWI764461) were added to 100 g of the aqueous solution of the aqueous resin and mixed, thereby obtaining an aqueous coating material. The contents in the aqueous coating material were compatible without suspension or precipitation. The prepared aqueous coating material was coated onto a stainless screw (series 4) to form a film with a thickness of 6 micrometers to 10 micrometers. The film was baked at 200° C. for 10 minutes to form an anti-corrosion coating layer on the screw. Then, the screw was taken to undergo a salt spray test according to the standard ASTM B117. The screw was corroded after about 400 hours in the salt spray test.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. An aqueous resin, being an ammonium salt formed by reacting an aromatic acid with an alkaline compound neutralized ring-opening intermediate compound,
wherein a ring-opening intermediate compound is formed by performing a ring-opening reaction of a copolymer containing maleic anhydride with a tertiary amino alcohol,
wherein the copolymer containing maleic anhydride has a chemical structure of 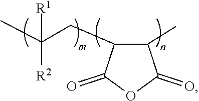
wherein R¹ is H or CH₃, R² is H, CH₃, or C₆H₅, m:n=1:3 to 3:1, and n=4 to 20,
wherein the tertiary amino alcohol has a chemical structure of 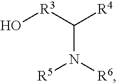
wherein R³ is C₁₋₁₀ alkylene group, R⁴ is H, C₁₋₁₀ alkyl group, or C₆₋₁₂ aromatic group, and each of R⁵ and R⁶ is independently C₁₋₁₀ alkyl group or C₆₋₁₂ aromatic group,
wherein the aromatic acid has a chemical structure of 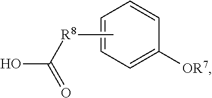
wherein R⁷ is H, C₁₋₁₀ alkyl group, or C₆₋₁₂ aromatic group, and R⁸ is C₁₋₅ alkylene group or

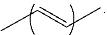

2. The aqueous resin as claimed in claim 1, wherein the copolymer containing maleic anhydride has a chemical structure of

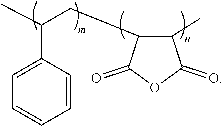

3. The aqueous resin as claimed in claim 1, wherein the tertiary amino alcohol has a chemical structure of

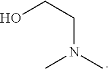

4. The aqueous resin as claimed in claim 1, wherein the aromatic acid has a chemical structure of

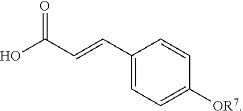

5. The aqueous resin as claimed in claim 1, wherein the aqueous resin has a weight average molecular weight of 1500 to 5000 g/mol.

6. The aqueous resin as claimed in claim 1, wherein the aqueous resin has a chemical structure of 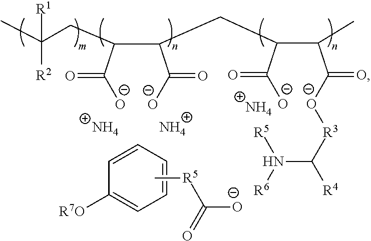
wherein o+p=n, p>0, and o is greater than or equal to 0.

7. An aqueous coating material, comprising:
100 parts by weight of water; and
50 to 100 parts by weight of the aqueous resin as claimed in claim 1.

8. The aqueous coating material as claimed in claim 7, further comprising 0.1 to 3 parts by weight of an additive, and the additive is a leveling agent, defoaming agent, preservative, or a combination thereof.

9. The aqueous coating material as claimed in claim 7, further comprising 10 to 100 parts by weight of a sol-gel, wherein the sol-gel comprises a silane compound, metal salt, and water.

10. An anti-corrosion coating layer, covering a surface of a metal article, wherein the anti-corrosion coating layer comprises the aqueous resin as claimed in claim 1.
